(19) United States
(12) Patent Application Publication
(10) Pub. No.: US 2020/0278925 A1
(43) Pub. Date: Sep. 3, 2020

(54) INFORMATION PROCESSING APPARATUS, INFORMATION PROCESSING METHOD, AND STORAGE MEDIUM

(71) Applicant: FUJITSU LIMITED, Kawasaki-shi (JP)

(72) Inventor: Satoshi Imamura, Kawasaki (JP)

(73) Assignee: FUJITSU LIMITED, Kawasaki-shi (JP)

(21) Appl. No.: 16/740,528

(22) Filed: Jan. 13, 2020

(30) Foreign Application Priority Data
Mar. 1, 2019 (JP) 2019-037599

(51) Int. Cl. G06F 12/02; G06F 12/1027; G06F 13/16; G06F 9/54; G06F 9/38; G06F 12/0882

(52) U.S. Cl. CPC G06F 12/0246; G06F 12/1027; G06F 12/0882; G06F 9/544; G06F 9/3836; G06F 13/1689

(57) ABSTRACT

An information processing apparatus includes a first memory whose writing unit is a first size; a second memory whose writing unit is a second size larger than the first size; and a processor configured to: receive a write instruction of write data of the first size to the second memory; generate, in the first memory, a first area of the second size corresponding to a predetermined area of the second size where the write data is written in the second memory; read stored data stored in the predetermined area of the second memory at a timing different from a timing at which the write instruction is received; update the stored data with the write data written to the first area; store the updated stored data in the predetermined area of the second memory; and write the write data to the first area created in the first memory.

### CROSS-REFERENCE TO RELATED APPLICATION

This application is based upon and claims the benefit of priority of the prior Japanese Patent Application No. 2019-37599, filed on Mar. 1, 2019, the entire contents of which are incorporated herein by reference.

### FIELD

The embodiments discussed herein are related to an information processing apparatus, an information processing method, and a storage medium.

### BACKGROUND

As block storage devices such as hard disk drives (HDDs) and solid state drives (SSDs) increase in speed, use of technology called a memory mapped file that expands a memory capacity using a block storage device has become common. In the memory mapped file, the memory capacity is expanded by mapping a file stored in the block storage device to a virtual address space of an application.

When the memory mapped file is not used, the application accesses the file stored in the block storage device using read and write system calls. On the other hand, in the memory mapped file, the application can access data in the file stored in the block storage device by load and store instructions. An accessed page is temporarily stored in a page cache on a memory such as a dynamic random access memory (DRAM). Such a memory mapped file allows accessing data stored in a file without significant modification to the application.

Moreover, when the memory mapped file is used, data is stored in the block storage device that is a nonvolatile storage medium, and thus data can be made permanent. Here, a write process for the file in the block storage device mapped to the virtual address space by the memory mapped file is referred to as a write process for a memory mapped area. In the write process for the memory mapped area, reading and writing of data between the block storage device and the memory are performed by a page fault handler (PFH).

In the write process for the memory mapped area, when a page as a writing target exists on a page cache on the memory, a central processing unit (CPU) directly writes data to the page as a writing target on the page cache. For example, when the page as a writing target exists on the page cache on the memory, high-speed access to data is possible.

On the other hand, when the page as a writing target does not exist on the page cache, the CPU performs a read modify write (RMW) on the target page. For example, a page fault occurs when the page as a writing target does not exist in the page cache. When the page fault occurs, the PFH receives an instruction from the CPU, reads a target page from the block storage device, and stores the target page in the page cache. This process is a read process. Reading a page from the block storage device is performed synchronously with a data writing process by the CPU. Next, the CPU writes data to the target page stored in the page cache. This process is a modification process. Thereafter, the PFH drives out the updated page asynchronously to the block storage device. For example, when a predetermined condition that the capacity of the updated page stored in the page cache exceeds a threshold, or the like is satisfied, the PFH reads data from the page cache and stores the data in the block storage device, and deletes the read data from the page cache.

Here, the CPU reads or writes data from or to the page cache in units of cache lines. For example, the CPU reads and writes data to and from the page cache in units of 64 bytes. On the other hand, reading or writing of data by the PFH depends on a handling unit of data between the OS and the block storage device. For example, the PFH reads or writes data from or to the page cache by 4 KBytes. Therefore, when the read modify write is performed on a page stored in the block storage device, data migration between the block storage device and the page cache is performed in processing units of the PFH larger than the units of cache lines.

As a technique of the memory mapped file, there is a conventional technique in which physical memory reservation and page table update processing by the PFH and input-output processing of the block storage device are executed in an overlapped manner. Further, there is a conventional technique in which all data in the file are cached in the memory when an initial page fault occurs. As related arts, for example, Japanese Laid-open Patent Publication No. 2007-188499, Japanese Laid-open Patent Publication No. H11-161527, and the like are disclosed.

However, in the read modify write, page reading is performed in synchronization with data writing, and thus read latency of the block storage device is added to at least DRAM write latency. Then, as described above, data exchange between the block storage device and the page cache is performed in processing units larger than the units of cache lines. Accordingly, latency when the read modify write is performed becomes larger than that of simple data writing to the page cache. For example, when latency of writing data to the DRAM is about 100 ns and latency of reading data from the block storage device is about 10 μs, an increase in latency of 100 times or more is expected.

For example, in an application that performs high-frequency random writing, prereading of the file system does not function, and high-frequency writing to a page that does not exist in the page cache may occur. Therefore, in an application that performs high-frequency random writing, the influence of an increase in latency due to the read modify write is large, and there is a possibility that the performance may be significantly reduced.

Furthermore, it is difficult to suppress an increase in latency when the read modify write is performed with the conventional technique in which processing of the PFH and input-output processing of the block storage device are executed in an overlapping manner. Moreover, in the conventional technique in which all data in the file are cached in the memory when an initial page fault occurs, there is a possibility that the data will not be completely loaded in the memory, and it is difficult to accelerate the write process. In view of the above, it is desirable to be capable of accelerating the write process.

### SUMMARY

According to an aspect of the embodiments, an information processing apparatus includes a first memory whose writing unit is a first size; a second memory whose writing unit is a second size larger than the first size; and a processor coupled to the first memory and the second memory and configured to: receive a write instruction of write data of the first size to the second memory; generate, in the first memory, a first area of the second size corresponding to a predetermined area of the second size where the write data is written in the second memory; read stored data stored in the predetermined area of the second memory at a timing different from a timing at which the write instruction is received; update the stored data with the write data written to the first area; store the updated stored data in the predetermined area of the second memory; and write the write data to the first area created in the first memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a hardware configuration diagram of an information processing apparatus according to a first embodiment;

FIG. 2 is a diagram illustrating an example of information stored in a page table;

FIG. 3 is a block diagram illustrating functions during data writing of the information processing apparatus according to the first embodiment;

FIG. 4 is a diagram illustrating states of a page cache and a block storage device when a page fault occurs during data writing;

FIG. 5 is a diagram illustrating states of the page cache and the block storage device during page driving out;

FIG. 6 is a flowchart of a memory access process by the information processing apparatus according to the first embodiment;

FIG. 7 is a flowchart of a page search process by a memory management unit (MMU);

FIG. 8 is a flowchart of a page control process when a page fault occurs according to the first embodiment;

FIG. 9 is a flowchart of a page driving-out process according to the first embodiment;

FIG. 10 is a hardware configuration diagram of an information processing apparatus according to a second embodiment;

FIG. 11 is a diagram illustrating an example of information stored in an identical value address table (IVAT);

FIG. 12 is a block diagram of an information processing apparatus according to the second embodiment;

FIG. 13 is a flowchart of a memory access process by a memory controller according to the second embodiment;

FIG. 14 is a flowchart of a page control process when a page fault occurs according to the second embodiment; and

FIG. 15 is a flowchart of a page driving-out process according to the second embodiment.

### DESCRIPTION OF EMBODIMENTS

Embodiments of an information processing apparatus, an information processing method, and an information processing program disclosed by the present application will be described in detail below based on the drawings. The following embodiments do not limit the information processing apparatus, the information processing method, and the information processing program disclosed in the present application.

### First Embodiment

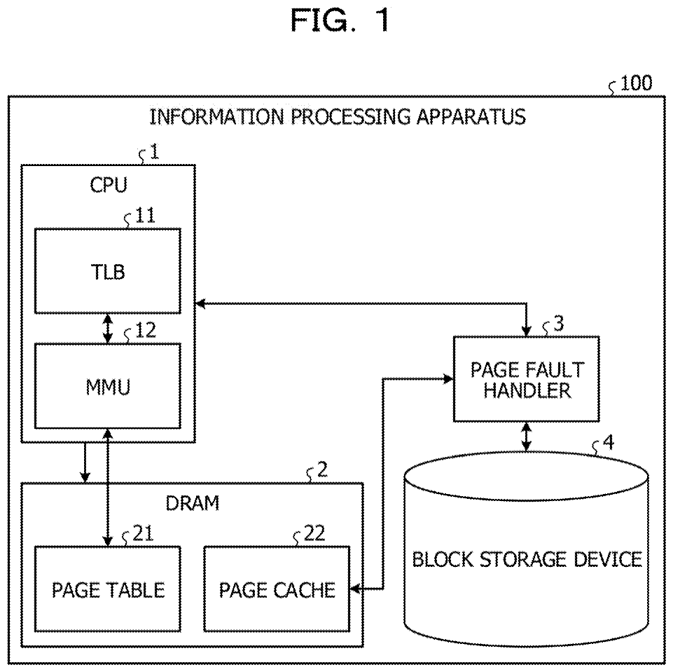

FIG. 1 is a hardware configuration diagram of the information processing apparatus according to a first embodiment. As illustrated in FIG. 1, an information processing apparatus 100 includes a central processing unit (CPU) 1, a dynamic random access memory (DRAM) 2, a page fault handler 3, and a block storage device 4.

The block storage device 4 is, for example, a hard disk, a solid state drive (SSD), or the like. Here, the information processing apparatus 100 has a memory mapped file that is a file stored in the block storage device 4 and mapped to a virtual address space. Hereinafter, an area where the memory mapped file in the block storage device 4 is stored is referred to as a memory mapped area. The block storage device 4 reads and writes data in units of pages. This block storage device 4 is an example of a “second storage unit”.

The CPU 1 includes a translation lookaside buffer (TLB) 11 and a memory management unit (MMU) 12. The TLB 11 is a cache for temporarily storing address translation information for translation between a virtual address and a physical address. For example, in the TLB 11, the CPU 1 stores information that associates a virtual address specified in a memory access request of a read command or a write command with a physical address in the DRAM 2.

When the CPU 1 receives a memory access request that is a read command or a write command of data, the CPU 1 searches the TLB 11 using a virtual address specified in the memory access request. When the address translation information exists in the TLB 11, such as when a hit occurs in the TLB 11, the CPU 1 obtains the physical address corresponding to the virtual address specified in the memory access request from the TLB 11. Thereafter, the CPU 1 performs memory access to the DRAM 2 using the obtained physical address.

On the other hand, when the address translation information corresponding to the virtual address specified in the access request does not exist in the TLB 11, the CPU 1 outputs the virtual address to the MMU 12 to execute a search of the page table 21. When the address translation information specified in the virtual address is stored in the page table 21, the address translation information corresponding to the virtual address specified in the memory access request is stored in the TLB 11 by the MMU 12. Therefore, the CPU 1 obtains a physical address from the TLB 11. Thereafter, the CPU 1 performs memory access to the DRAM 2 using the obtained physical address.

On the other hand, if the address translation information specified by the virtual address does not exist in the page table 21, a page fault occurs, and the CPU 1 notifies the page fault handler 3 of the virtual address. Thereafter, the CPU 1 causes the MMU 12 to perform a page table search, obtains a physical address from the TLB 11, and performs memory access to the DRAM 2 using the obtained physical address.

The MMU 12 is dedicated hardware that performs translation between a virtual address and a physical address, and the like. The MMU 12 obtains a physical address corresponding to the virtual address using the page table 21 when the address translation information is not stored in the TLB 11.

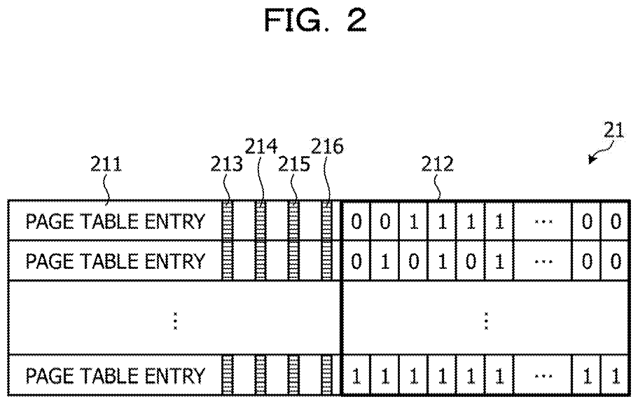

The DRAM 2 has a page table 21 and a page cache 22. The page table 21 has a data structure that associates virtual addresses with physical addresses. The page table 21 according to the present embodiment retains information illustrated in FIG. 2. FIG. 2 is a diagram illustrating an example of information stored in the page table. The page table 21 includes a page table entry (PTE) 211 and update state information 212.

The page table entry 211 is an element that stores page information in the DRAM 2. The page information includes a physical address, an access right, and the like. Further, the page table entry 211 according to the present embodiment has a memory mapped bit 213 indicating whether the page exists in the memory mapped area or not. The page table entry 211 has an R-W bit 214 indicating whether the corresponding page is writable or not and a presence bit 215 indicating whether the corresponding page exists or not on the page cache 22. Moreover, the page table entry 211 has a dirty bit 216 that determines whether or not writing has been performed on the page.

The update state information 212 has for each page a bitmap corresponding to each cache line included in the page. For example, when the size of one page is 4 KBytes and the size of the cache line is 64 Bytes, the update state information 212 has a 64-bit bitmap for each page. Then, as will be described later, when the value of a specific bit included in the bitmap is 1, the update state information 212 indicates that the cache line corresponding to the specific bit has been updated. Conversely, when the value of a specific bit included in the bitmap is 0, the update state information 212 indicates that the cache line corresponding to the specific bit has not been updated.

In the page cache 22, the memory mapped file stored in the block storage device 4 is temporarily stored. Data of the memory mapped file stored in the block storage device 4 is stored in the page cache 22 and then obtained by the CPU 1.

The page cache 22 is read and written by the CPU 1 in units of cache lines. In the page cache 22, the page fault handler 3 reads and writes data in units of pages in accordance with the data processing units in the block storage device 4. For example, one page is 4 KByte. The page includes a plurality of cache lines, and one cache line is, for example, 64 bytes. For example, the page cache 22 is accessed in different units by the CPU 1 and the page fault handler 3. This page cache 22 is an example of a “first storage unit”.

The page fault handler 3 reads from and writes to the memory mapped file stored in the block storage device 4. For example, when data specified by a read command does not exist in the page cache 22, upon reception of a read command for target data from the CPU 1, the page fault handler 3 reads target data from the block storage device 4. Then, the page fault handler 3 stores the read data in the page cache 22. Thereafter, the page fault handler 3 notifies the CPU 1 of data reading.

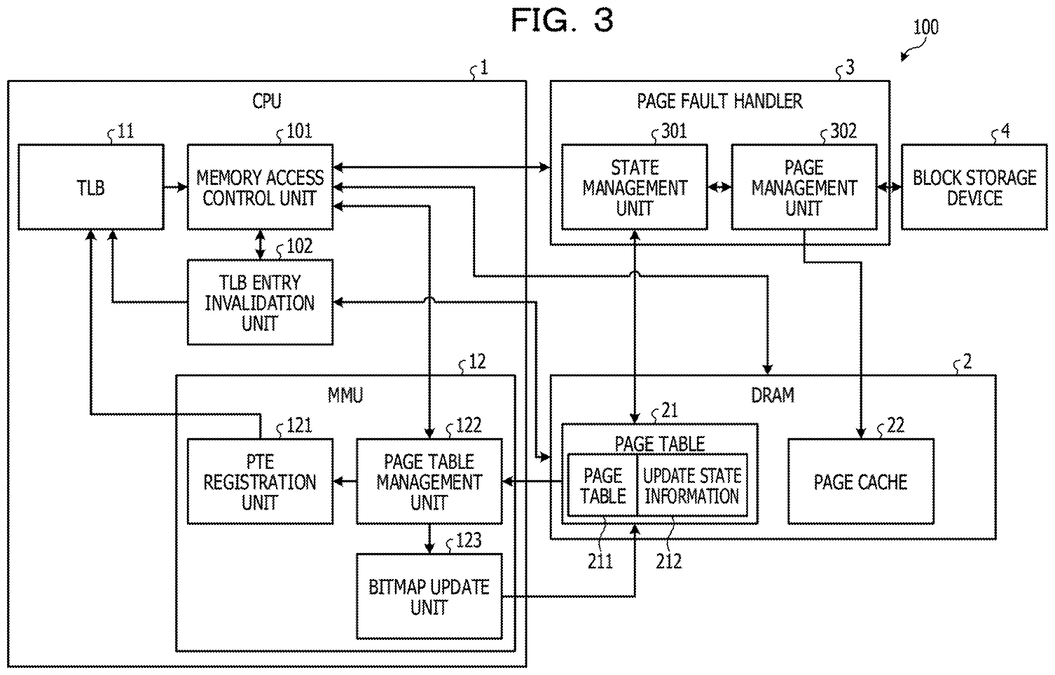

Next, a function for processing a memory access request in the information processing apparatus 100 according to the present embodiment will be described in detail with reference to FIG. 3. FIG. 3 is a block diagram illustrating functions during data writing of the information processing apparatus according to the first embodiment.

The CPU 1 has a memory access control unit 101 and a TLB entry invalidation unit 102. Further, the MMU 12 also has a PTE registration unit 121, a page table management unit 122, and a bitmap update unit 123.

The memory access control unit 101 obtains a memory access request issued from an application executed by the CPU 1. Hereinafter, data specified as a target of reading or writing by the memory access request is referred to as “target data”, and a page including target data is referred to as “target page”. The memory access request that is a write command is an example of a “write instruction”.

Next, the memory access control unit 101 determines whether or not the address translation information corresponding to a virtual address indicating target data specified in the memory access request exists in the TLB 11. This TLB 11 is an example of a “temporary holding unit”. Then, the virtual address is an example of “write destination information”, and the address translation information is an example of “position information”.

When the virtual address causes a hit in the TLB 11, the memory access control unit 101 obtains a physical address corresponding to the virtual address specified in the memory access request from the TLB 111. Next, the memory access control unit 101 outputs information on a target page to the TLB entry invalidation unit 102.

Thereafter, the memory access control unit 101 executes reading or writing of the target data from or to the DRAM 2 in response to the memory access request using the physical address obtained from the TLB 11. The memory access control unit 101 reads and writes data from and to the page cache 22 in units of 64 bytes, which is the size of the cache line in the page cache 22, for example. This unit of data processing for the page cache 22 by the memory access control unit 101 is an example of “first size”.

Here, when the target page is a writable page and is a page included in the memory mapped area, an entry of the TLB 11 of the target page is deleted. Accordingly, during a next access request for the page, the memory access control unit 101 requests the page table management unit 122 of the MMU 12 to perform a page table search.

On the other hand, when the virtual address causes a miss in the TLB 11, the memory access control unit 101 requests the page table management unit 122 of the MMU 12 to perform a page table search.

Thereafter, the memory access control unit 101 receives a page fault notification or a request for reprocessing the access request from the page table management unit 122. Upon reception of the page fault notification, the memory access control unit 101 instructs a state management unit 301 to obtain the target page specified in the memory access request from the block storage device 4. Thereafter, the memory access control unit 101 receives a notification of registration completion of the page table entry 211 from the state management unit 301. Then, the memory access control unit 101 searches the TLB 11. In this case, the address translation information of the target data is not yet stored in the TLB 11. Accordingly, the memory access control unit 101 causes the page table management unit 122 to perform the page table search again, and stores the address translation information of the target page in the TLB 11.

Here, since the address translation information of the virtual address indicating the target data is stored in the TLB 11, the memory access control unit 101 obtains the physical address corresponding to the virtual address from the TLB 11. Thereafter, the memory access control unit 101 outputs information on the target data specified in the memory access request to the TLB entry invalidation unit 102. Thereafter, the memory access control unit 101 reads or writes data from or to the DRAM 2 in response to the memory access request using the physical address obtained from the TLB 11. The memory access control unit 101 is an example of a “writing unit”.

The TLB entry invalidation unit 102 receives from the memory access control unit 101 an input of the information on the target data specified in the memory access request. Next, the TLB entry invalidation unit 102 checks the page table entry 211 of the target page specified in the memory access request in the page table 21. Then, the TLB entry invalidation unit 102 obtains values of the R-W bit 214 and the memory mapped bit 213 in the page table entry 211. When the R-W bit 214 is 1 and the memory mapped bit 213 is 1, the TLB entry invalidation unit 102 deletes the address translation information corresponding to the virtual address of the target data in the TLB 11, and invalidates an entry of the target data in the TLB 11.

Here, when the R-W bit 214 is 1, writing to the page is possible. Further, when the memory mapped bit 213 is 1, the page is a page of the memory mapped area. For example, when the target page is a page that exists in the memory mapped area and is a writable page, the TLB entry invalidation unit 102 sets to cause a miss in the TLB 11 during a next memory access request for that page. Thus, the page table search of the MMU 12 is executed during the next memory access request for that page. Conversely, when the page is not writable or not present in the memory mapped area, the page will not be a target of an asynchronous write process by the page fault handler 3, and thus the TLB entry invalidation unit 102 maintains the entry of the TLB 11 as it is.

Next, functions of the MMU 12 will be described. The page table management unit 122 receives an input of a page table search request from the memory access control unit 101. The page table search request includes a virtual address of target data to be accessed.

The page table management unit 122 searches the page table 21 using the virtual address included in the page table search request. When the page table entry 211 of a target page specified in a data access request does not exist in the page table 21, the page table management unit 122 notifies a page fault to the memory access control unit 101 and causes a page fault to occur.

On the other hand, when the page table entry 211 of the target page specified in the data access request exists in the page table 21, the page table management unit 122 checks an access right of the target page. When the access right is invalid, the page table management unit 122 notifies a page fault to the memory access control unit 101 and causes the page fault to occur.

On the other hand, when the access right is valid, the page table management unit 122 checks the presence bit 215 of the page table entry 211 of the target page in the page table 21. When the presence bit 215 is 0 and the target page does not exist in the page cache 22, the page table management unit 122 notifies the page fault to the memory access control unit 101 and causes the page fault to occur.

On the other hand, when the presence bit 215 is 1 and the target page exists in the page cache 22, the page table management unit 122 determines whether the data access request is a write command or a read command. When the data access request is a read command, the page table management unit 122 obtains address translation information using the page table entry 211 of the target page. Then, the page table management unit 122 outputs the virtual address of the target page to the PTE registration unit 121 and requests for storing the address translation information of the target page in the TLB 11. Thereafter, the page table management unit 122 outputs a request for reprocessing the access request to the memory access control unit 101.

On the other hand, when the data access request is a write command, the page table management unit 122 outputs a request for updating the update state information 212 to the bitmap update unit 123. Thereafter, the page table management unit 122 obtains address translation information using the page table entry 211 of the target page. Then, the page table management unit 122 outputs the virtual address of the target page to the PTE registration unit 121 and requests for storing the address translation information of the target page in the TLB 11. Thereafter, the page table management unit 122 outputs a request for reprocessing the access request to the memory access control unit 101. The page table management unit 122 is an example of a “write control unit”.

The bitmap update unit 123 receives an input of the update request for the update state information 212 from the page table management unit 122. Then, the bitmap update unit 123 sets the bit at a position of write data in the target page to 1 in the update state information 212 corresponding to the page table entry 211 of the target page.

The PTE registration unit 121 receives a request for storing the address translation information of the target page in the TLB 11 from the page table management unit 122 together with an input of the virtual address of the target page. Then, the PTE registration unit 121 registers the obtained address translation information between the virtual address and the physical address in the TLB 11. Thus, the memory access control unit 101 that has received the request for processing the access request for the target page again searches the TLB 11 according to the access request, resulting in a hit in the TLB 11 and processing of the access request.

Next, functions of the page fault handler 3 will be described. The page fault handler 3 has a state management unit 301 and a page management unit 302.

When a page fault occurs, the state management unit 301 receives from the memory access control unit 101 a request for obtaining target data specified in a memory access request from the block storage device 4. At this time, the state management unit 301 obtains a virtual address specified in the memory access request.

Next, the state management unit 301 checks whether or not the obtained virtual address is included in a virtual memory space allocated to the process that has output the access request. When the virtual address is not included in the virtual memory space allocated to the process that has output the access request, the state management unit 301 outputs an error response to the memory access control unit 101.

On the other hand, when the virtual address is included in the virtual memory space allocated to the process that has output the access request, the state management unit 301 refers to a write flag in the virtual memory space to determine whether it is a writable area or not. When a write request is made for a non-writable area, the state management unit 301 outputs an error response to the memory access control unit 101.

Thereafter, the state management unit 301 requests the page management unit 302 to search the page cache 22. Thereafter, when the target page exists in the page cache 22, the state management unit 301 receives a notification of hit in the page cache 22 from the page management unit 302. The case where the target page exists in the page cache 22 in this state is a case where a physical page allocated by a process other than the process that has issued the memory access request is accessed. In this case, it may be said that all data of the target page are read from the block storage device 4 and correct data exists in the page cache 22. Accordingly, the state management unit 301 initializes all bits of the update state information 212 of the page table entry 211 indicating the target page in the page table 21 with 1. Thus, all the cache lines of the target page are in an updated state. Thereafter, the state management unit 301 transmits a notification of registration completion of the page table entry 211 to the memory access control unit 101.

On the other hand, when the target page does not exist in the page cache 22, the state management unit 301 receives a notification of empty page allocation or a notification of storage completion of the target page in the page cache 22 from the page management unit 302. When the notification of empty page allocation is received, it may be said that an empty page corresponding to the target page is generated in the page cache 22. Accordingly, the state management unit 301 initializes all bits of the update state information 212 of the page table entry 211 indicating the target page in the page table 21 with 0. Thus, all the cache lines of the target page are in a non-updated state. Thereafter, the state management unit 301 transmits a notification of registration completion of the page table entry 211 to the memory access control unit 101.

On the other hand, upon reception of the notification of storage completion of the target page in the page cache 22, all data of the target page are read from the block storage device 4 and correct data exists in the page cache 22. Accordingly, the state management unit 301 initializes all bits of the update state information 212 of the page table entry 211 indicating the target page in the page table 21 with 1. Thus, all the cache lines of the target page are in an updated state. Thereafter, the state management unit 301 transmits a notification of registration completion of the page table entry 211 to the memory access control unit 101.

Further, when an updated page stored in the page cache 22 exceeds a predetermined threshold, the state management unit 301 determines a driving-out target page from the page cache 22 based on least recently used (LRU). Here, in the present embodiment, although a case where the threshold is exceeded is set as a start condition of the page driving-out process from the page cache 22, another condition may be used as this condition as long as the amount of update pages stored in the page cache 22 is properly adjustable. For example, the page driving-out process may be performed at a certain cycle. Further, in the present embodiment, the driving-out target page is determined based on the LRU. However, the driving-out target page may be determined using another algorithm. For example, the driving-out target page may be determined according to usage frequency of each page. The timing of the page driving-out process from the page cache 22 is an example of “a timing different from a timing at which the write instruction is received”.

Next, the state management unit 301 checks the dirty bit 216 in the page table entry 211 of the driving-out target page. When the dirty bit 216 of the driving-out target page is 0 and it is a non-written page, the state management unit 301 sets the presence bit 215 of the page table entry 211 of the driving-out target page to 0. For example, the state management unit 301 indicates that the driving-out target page is not stored in the memory (DRAM 2). Thereafter, the state management unit 301 outputs to the page management unit 302 a request for deleting the driving-out target page from the page cache 22.

On the other hand, when the dirty bit 216 is 1 and the page is a page that has been written, the state management unit 301 checks the update state information 212 of the driving-out target page. When all the bits of the update state information 212 of the driving-out target page are 1, such as when all the cache lines of the driving-out target page are updated, the state management unit 301 outputs an instruction to write the driving-out target page to the page management unit 302. Thereafter, the state management unit 301 sets the presence bit 215 of the page table entry 211 of the driving-out target page to 0. Thereafter, the state management unit 301 outputs to the page management unit 302 a request for deleting the driving-out target page from the page cache 22.

When any bit of the update state information 212 of the driving-out target page is 0, such as when the driving-out target page has a non-updated cache line, the state management unit 301 instructs the page management unit 302 to perform a read modify write of the driving-out target page. In this case, the state management unit 301 notifies the page management unit 302 of position information of the cache line updated using a bitmap of the update state information 212. The update state information 212 is an example of “write position information”.

Next, the state management unit 30 sets the presence bit 215 of the page table entry 211 of the driving-out target page to 0. Thereafter, the state management unit 301 outputs to the page management unit 302 a request for deleting the driving-out target page from the page cache 22.

The page management unit 302 manages data movement between the page cache 22 and the block storage device 4. The page management unit 302 reads and writes data in units of pages. For example, when one page is 4 Kbytes, the page management unit 302 reads and writes data to and from the page cache 22 in units of 4 KBytes. The unit of data processing by the page management unit 302 is an example of “second size”. Further, the page management unit 302 is an example of an “update management unit”.

The page management unit 302 receives a request for searching the page cache 22 from the state management unit 301. At this time, the page management unit 302 obtains a file offset of the target data. Next, the page management unit 302 searches the page cache 22 with the file offset and determines whether the target page exists in the page cache 22 or not. When the target page exists in the page cache 22, the page management unit 302 outputs a notification of hit in the page cache 22 to the state management unit 301.

On the other hand, when the target page does not exist in the page cache 22, the page management unit 302 allocates an empty page corresponding to the target page to the page cache 22. This empty page is an example of a “first area”. Then, the area of the block storage device 4 that stores the target page is an example of the “predetermined area”.

Next, the page management unit 302 determines whether the access request is a read command or a write command. When the access request is a write command, the page management unit 302 outputs a notification of empty page allocation to the state management unit 301.

On the other hand, when the access request is a read command, the page management unit 302 obtains data specified by the file offset from the block storage device 4. Then, the page management unit 302 stores the obtained data in the generated empty page in the page cache 22. Thereafter, the page management unit 302 outputs a notification of storage completion of the target page in the page cache 22 to the state management unit 301.

The page management unit 302 receives from the state management unit 301 an input of an instruction to write the driving-out target page. Next, the page management unit 302 reads the specified driving-out target page from the page cache 22. Then, the page management unit 302 writes the read page to the block storage device 4 to update the page.

The page management unit 302 receives an input of a read modify write instruction for the driving-out target page from the state management unit 301. Next, the page management unit 302 reads the specified driving-out target page from the page cache 22. The page management unit 302 reads a page corresponding to the specified driving-out target page from the block storage device 4. Then, the page management unit 302 updates the cache line at a same position of the page read from the block storage device 4 with data stored in the updated cache line in the driving-out target page read from the page cache 22. Thereafter, the page management unit 302 writes the page with the updated cache line to the block storage device 4 to update the page.

The page management unit 302 receives from the state management unit 301 an input of the request for deleting the driving-out target page from the page cache 22. In this case, the page management unit 302 deletes the specified driving-out target page from the page cache 22.

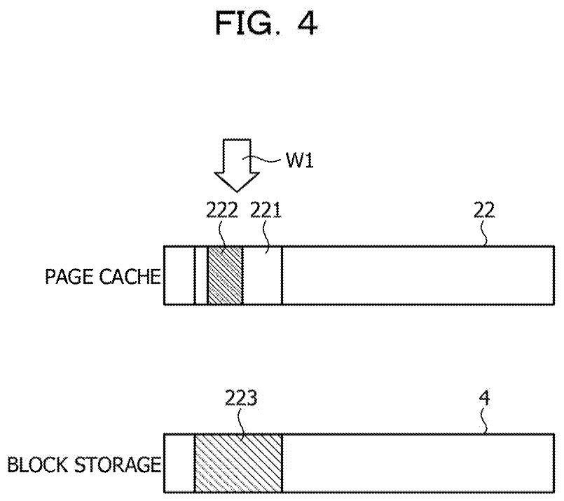

Here, with reference to FIG. 4, an outline of processing during writing by the information processing apparatus 100 according to the present embodiment will be described. FIG. 4 is a diagram illustrating states of a page cache and a block storage device when a page fault occurs during data writing.

The memory access control unit 101 receives a memory access request for writing to a cache line included in a page 223 stored in the block storage device 4 from an application executed by the CPU 1. When a page fault occurs, the page management unit 302 generates on the page cache 22 an empty page 221 corresponding to the page 223 on the block storage device 4. Thereafter, the memory access control unit 101 performs a write process W1 to write data to an area 222 specified in the memory access request in the empty page 221 generated in the page cache 22.

In this state, the page 223 on the block storage device 4 is not updated. On the other hand, the empty page 221 corresponding to the page 223 is generated on the page cache 22, and update data is written to the area 222 specified in the memory access request therein. For example, data writing to the page cache 22 is performed in synchronization with the memory access request of a write command.

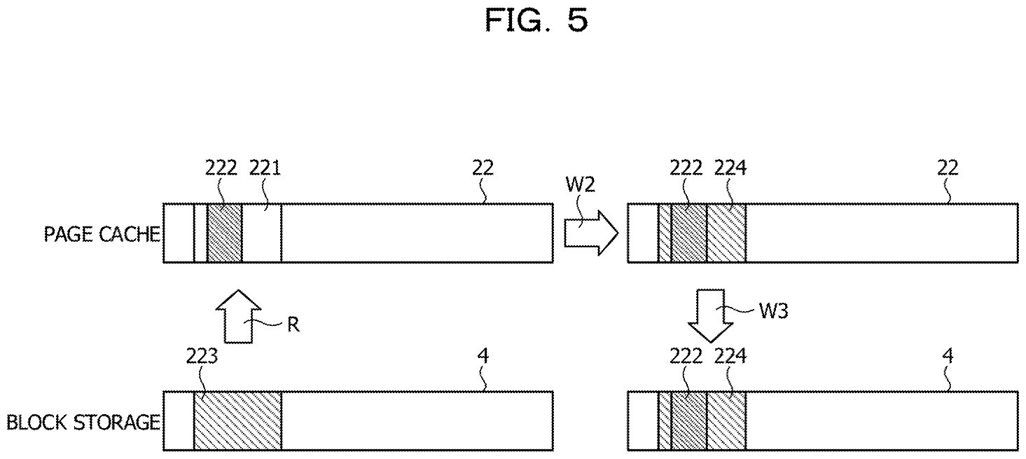

Next, an overview of the page driving-out process from the page cache 22 by the information processing apparatus 100 according to the present embodiment will be described with reference to FIG. 5. FIG. 5 is a diagram illustrating states of the page cache and the block storage device during page driving out.

When a start condition for the page driving-out process is satisfied, the page management unit 302 executes a read process R to read the page 223 from the block storage device 4. Then, the page management unit 302 executes a write process W2 to write a page 224, which is obtained by merging the read page 223 and the data of the area 222 included in the empty page 221, to the page cache 22. Thus, the page cache 22 stores the page 224 including the data of the area 222. Thereafter, the page management unit 302 stores the page 224 stored in the page cache 22 in the area of the page 223 of the block storage device 4. Thus, update of the page 223 stored in the block storage device 4 to the page 224 is completed. In this manner, update of a page on the block storage device 4 is performed asynchronously with the memory access request of a write command.

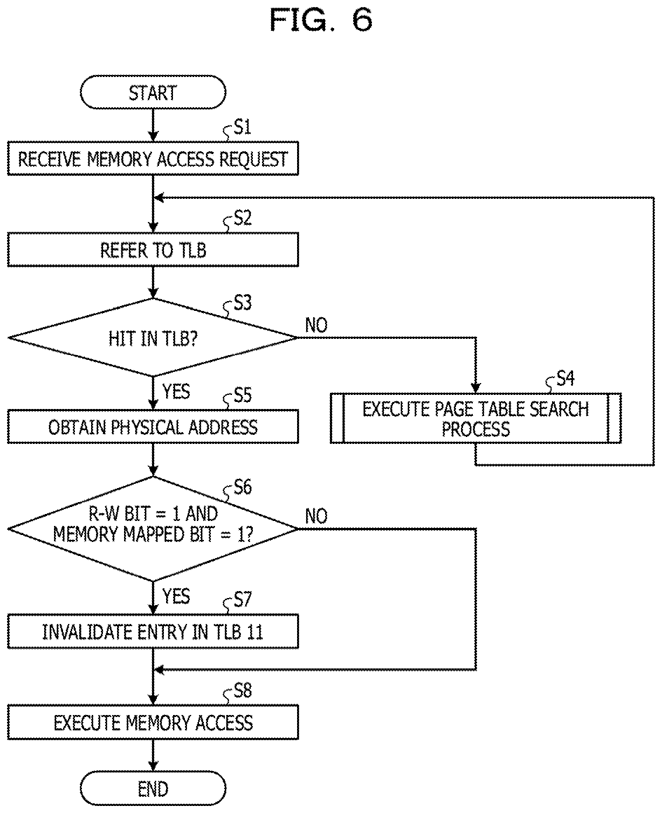

Next, a flow of a memory access process by the information processing apparatus 100 according to the present embodiment will be described with reference to FIG. 6. FIG. 6 is a flowchart of the memory access process performed by the information processing apparatus according to the first embodiment.

The memory access control unit 101 receives a memory access request from an application executed by the CPU 1 (S1).

Next, the memory access control unit 101 refers to the TLB 11 (S2).

Then, based on whether or not address translation information corresponding to a virtual address specified in the memory access request is stored in the TLB 11, the memory access control unit 101 determines whether or not the virtual address causes a hit in the TLB 11 (S3).

If a miss occurs in the TLB 11 (No in S3), the memory access control unit 101 causes the MMU 12 to execute a page table search process (S4), and then returns to S2.

On the other hand, when a hit occurs in the TLB 11 (Yes in S3), the memory access control unit 101 obtains a physical address from the address translation information that the TLB 11 has (S5).

Next, the memory access control unit 101 checks the R-W bit 214 and the memory mapped bit 213 of a page table entry 211 of a target page specified in the memory access request. Then, the memory access control unit 101 determines whether or not the R-W bit 214 is 1 and the memory mapped bit 213 is 1 (S6). For example, the memory access control unit 101 determines whether or not the target page is a page that is writable and is arranged in a memory mapped area.

When the R-W bit 214 is 0 or the memory mapped bit 213 is 0 (No in S6), the memory access control unit 101 proceeds to S8.

On the other hand, when the R-W bit 214 is 1 and the memory mapped bit 213 is 1 (Yes in S6), the memory access control unit 101 deletes and invalidates the entry of the target page in the TLB 11 (S7).

Thereafter, the memory access control unit 101 performs memory access using the physical address of the target page (S8).

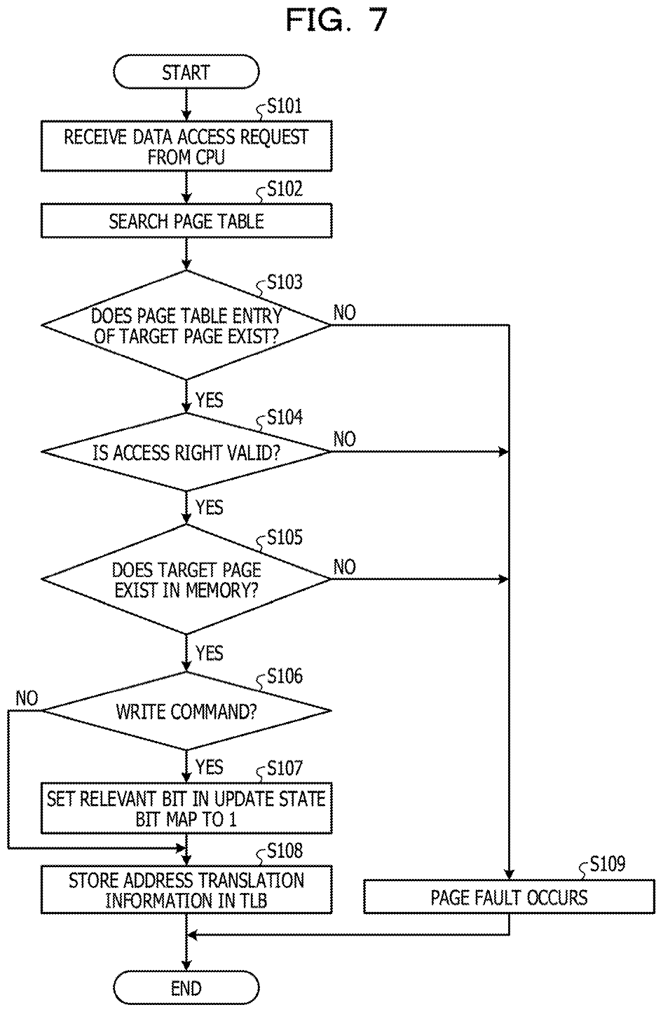

Next, a flow of a page table search process by the MMU 12 will be described with reference to FIG. 7. FIG. 7 is a flowchart of the page search process by the MMU. The process described with the flow of FIG. 7 is an example of a process executed in S4 of FIG. 6.

The page table management unit 122 receives a data access request based on a memory access request from the memory access control unit 101 (S101).

Next, the page table management unit 122 obtains a virtual address included in the data access request, and searches the page table 21 using the obtained virtual address (S102).

Then, the page table management unit 122 determines whether a page table entry 211 of a target page specified by the virtual address exists or not (S103). When the page table entry 211 of the target page does not exist (No in S103), the page table management unit 122 proceeds to S109.

On the other hand, when the page table entry 211 of the target page exists (Yes in S103), the page table management unit 122 determines whether an access right is valid or not (S104). When the access right is invalid (No in S104), the page table management unit 122 proceeds to S109.

On the other hand, when the access right is valid (Yes in S104), the page table management unit 122 checks the presence bit 215 of the page table entry 211 of the target page. Then, the page table management unit 122 determines whether or not the target page exists in the memory (DRAM 2) (S105). When the presence bit 215 is 0 and the target page does not exist in the memory (DRAM 2) (No in S105), the page table management unit 122 proceeds to S109.

On the other hand, when the presence bit 215 is 1 and the target page exists in the memory (DRAM 2) (Yes in S105), the page table management unit 122 determines whether the data access request is a write command or not. (S106). When the data access request is not a write command (No in S106), the page table management unit 122 proceeds to S108.

On the other hand, when the data access request is a write command (Yes in S106), the page table management unit 122 outputs a request for updating the update state information 212 to the bitmap update unit 123. The bitmap update unit 123 sets 1 to a bit that is a cache line to which data is written in the update state information 212 of the target page (S107).

Thereafter, the page table management unit 122 obtains address translation information using the page table entry 211 of the target page. Then, the page table management unit 122 outputs the virtual address of the target page to the PTE registration unit 121 and requests for storing address translation information of the target page in the TLB 11. The PTE registration unit 121 receives the request for storing the address translation information of the target page in the TLB 11 from the page table management unit 122, and stores the address translation information in the TLB 11 (S108).

On the other hand, when the page table entry 211 of the target page does not exist (No in S103), the page table management unit 122 notifies a page fault to the memory access control unit 101 and causes a page fault to occur (S109). On the other hand, also when the access right is invalid (No in S104) and when the target page does not exist in the page cache 22 (No in S105), the page table management unit 122 similarly causes a page fault to occur (S109).

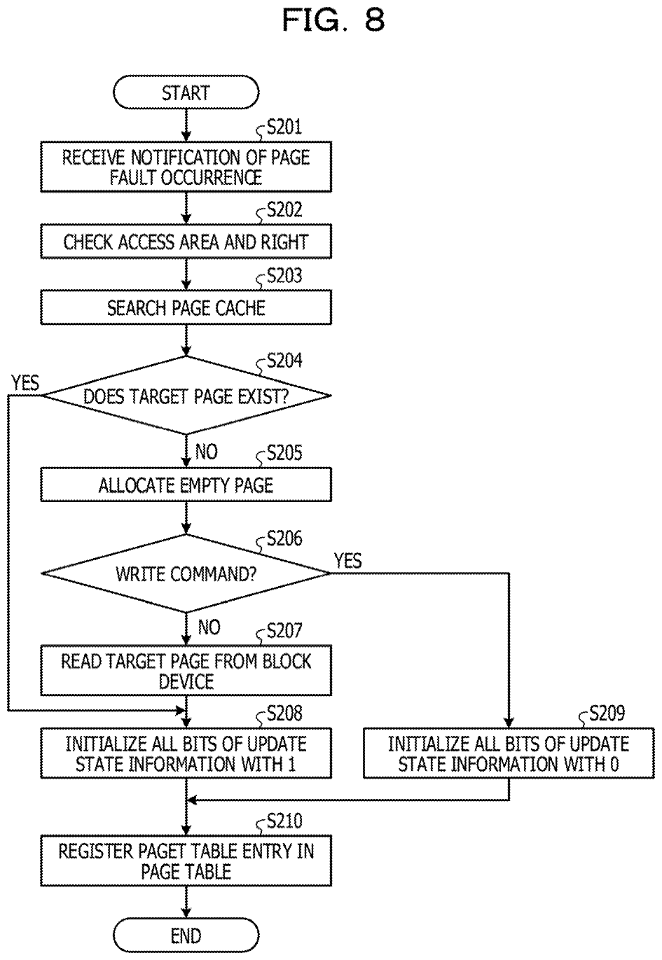

Next, a flow of a page control process by the page fault handler 3 when a page fault occurs according to the present embodiment will be described with reference to FIG. 8. FIG. 8 is a flowchart of a page control process when a page fault occurs according to the first embodiment.

The memory access control unit 101 receives a notification of page fault from the page table management unit 122. Then, the memory access control unit 101 transmits a notification of page fault occurrence to the state management unit 301. The state management unit 301 receives the notification of page fault occurrence from the memory access control unit 101 (S201).

Next, the state management unit 301 checks validity of an access area based on whether or not a virtual address indicating a target page is included in a virtual memory space allocated to the process that has transmitted the memory access request. The state management unit 301 refers to a write flag of the virtual memory space including the virtual address and checks whether it is a writable area or not (S202). Here, a case where the access area is valid and is a writable area will be described.

The state management unit 301 outputs a request for searching the page cache 22 to the page management unit 302. Upon reception of the request for searching the page cache 22, the page management unit 302 searches the page cache 22 (S203).

Then, the page management unit 302 determines whether the target page exists in the page cache 22 or not (S204). When the target page exists in the page cache 22 (Yes in S204), the page management unit 302 outputs a notification of hit in the page cache 22 to the state management unit 301, and proceeds to S208.

On the other hand, when the target page does not exist in the page cache 22 (No in S204), the page management unit 302 allocates an empty page to the area corresponding to the target page on the page cache 22 (S205).

Next, the page management unit 302 determines whether the memory access request is a write command or not (S206). When the memory access request is not a write command (No in S206), the page management unit 302 reads the target page from the block storage device 4 (S207). Then, the page management unit 302 stores data of the read target page in the generated empty page in the page cache 22. Thereafter, the page management unit 302 outputs a notification of storage completion of the target page in the page cache 22 to the state management unit 301.

The state management unit 301 receives from the page management unit 302 an input of the notification of hit in the page cache 22 or the notification of storage completion of the target page in the page cache 22. Then, the state management unit 301 initializes all bits of the bitmap of the update state information 212 of the target page with 1 (S208).

On the other hand, when the memory access request is a write command (Yes in S206), the page management unit 302 outputs a notification of empty page allocation completion to the state management unit 301. When the state management unit 301 receives an input of the notification of the empty page allocation completion from the page management unit 302, the state management unit 301 initializes all the bits of the bitmap of the update state information 212 of the target page with 0 (S209).

Thereafter, the state management unit 301 registers the page table entry 211 of the target page in the page table 21 (S210).

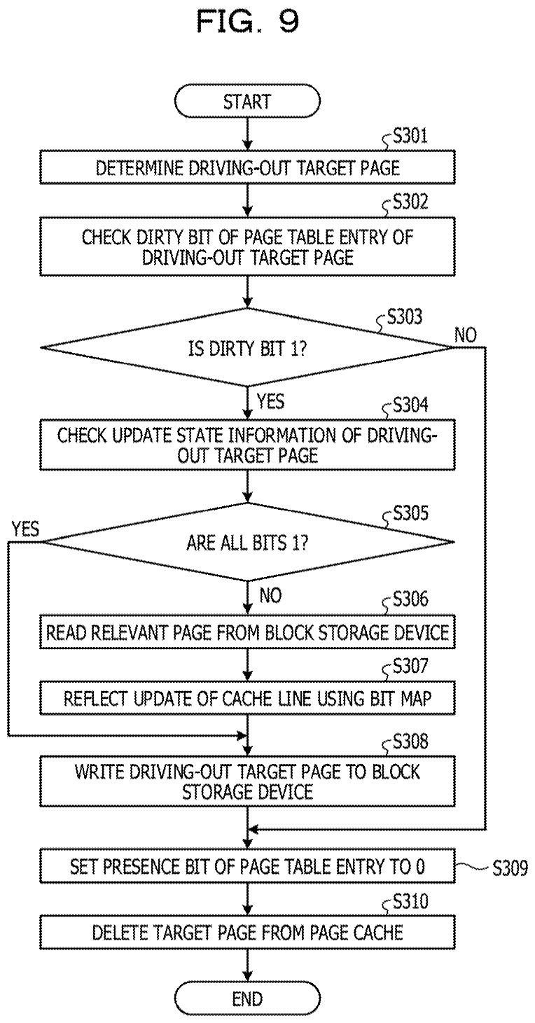

Next, with reference to FIG. 9, a flow of a page driving-out process from the page cache 22 by the page fault handler 3 according to the present embodiment will be described. FIG. 9 is a flowchart of the page driving-out process according to the first embodiment. Here, a process after a start condition of the page driving-out process is satisfied will be described.

The state management unit 301 determines a driving-out target page from pages stored in the page cache 22 by the LRU (S301).

Next, the state management unit 301 checks the dirty bit 216 of the page table entry 211 of the driving-out target page (S302), and determines whether or not new data is written to the driving-out target page (S303). When the dirty bit 216 is 0 (No in S303), the state management unit 301 proceeds to S309.

On the other hand, when the dirty bit 216 is 1 (Yes in S303), the state management unit 301 checks update state information 212 of the driving-out target page (S304).

Then, the state management unit 301 determines whether or not all the bits of the bitmap of the update state information 212 of the driving-out target page are 1 (S305). For example, the state management unit 301 determines whether or not a cache line that has not been updated exists in the driving-out target page.

When all the bits of the bitmap of the update state information 212 are 1 (Yes in S305), the state management unit 301 outputs an instruction to write the driving-out target page to the block storage device 4 to the page management unit 302. Then, the process proceeds to S308.

On the other hand, when a bit of 0 exists in the bitmap of the update state information 212 (No in S305), the state management unit 301 outputs an instruction of read modify write to the page management unit 302. Upon reception of an input of the instruction of read modify write, the page management unit 302 reads a page corresponding to the driving-out target page from the block storage device 4 (S306).

Next, the page management unit 302 obtains from the state management unit 301 information of a position of a cache line updated using the update state information 212. Next, the page management unit 302 updates updated data included in an empty page in the page cache 22 to the read page according to the information of the position of the updated cache line. Then, the page management unit 302 writes the updated page to the page cache 22. Thus, the page management unit 302 reflects the update of the cache line on the read page (S307).

The page management unit 302 writes the driving-out target page stored in the page cache 22 to the block storage device 4 (S308).

Thereafter, the state management unit 301 sets the presence bit 215 in the page table entry 211 of the driving-out target page to 0 (S309). Then, the state management unit 301 outputs a request for deleting the driving-out target page to the page management unit 302.

The page management unit 302 receives an input of the request for deleting the driving-out target page from the state management unit 301. Then, the page management unit 302 deletes the driving-out target page from the page cache 22 (S310).

In the information processing apparatus according to the present embodiment, the unit for reading and writing data from and to the block storage device is different from the unit for reading and writing data from and to a page cache. Therefore, as described above, the information processing apparatus according to the present embodiment generates an empty page in the page cache when writing is performed on a memory mapped file that is not stored in the page cache, and stores write data in the empty page. Thereafter, the information processing apparatus updates a page to which data is written at a timing different from the timing at which a write command is received. For example, the information processing apparatus according to the present embodiment performs reading of data from the block storage device in updating of data stored in the block storage device asynchronously with respect to the write command as needed. Thus, it is possible to avoid addition of read latency of data from the block storage device in a write process of data, and accelerate the write process. For example, when an application that performs high-frequency random writing is operated, it is possible to reduce a decrease in performance.

### Second Embodiment

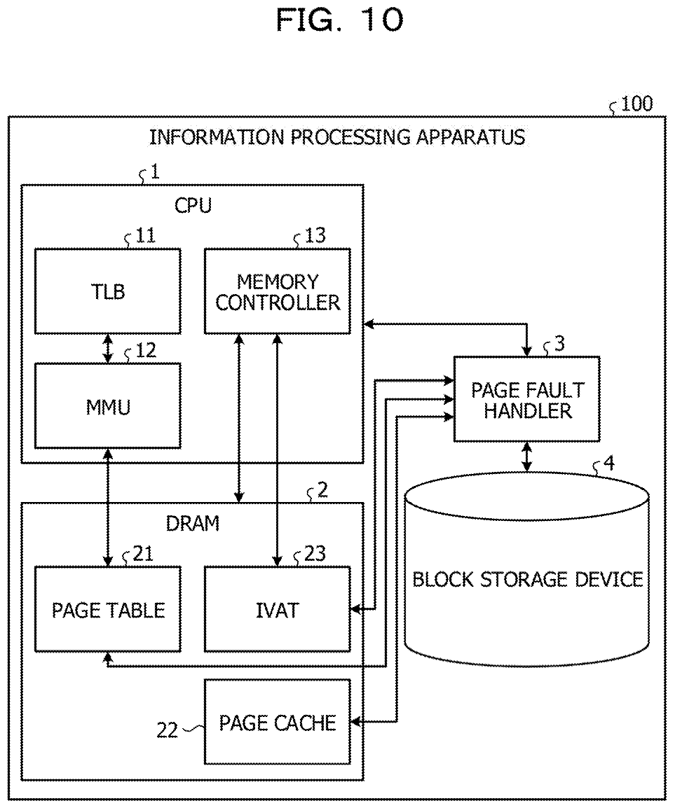

FIG. 10 is a hardware configuration diagram of an information processing apparatus according to a second embodiment. A DRAM 2 according to the present embodiment has an identical value address table (IVAT) 23. The information processing apparatus 100 according to the present embodiment initializes an allocated empty page with a specific initial value, and asynchronously updates a portion where a value other than the initial value is written.

Here, when an empty page allocated to the page cache 22 is initialized with a specific initial value during data writing, a portion where data other than the initial value is written is an update position, and thus it is possible to update the page. However, the value of written data may accidentally match the initial value. Therefore, it is preferable to provide a mechanism capable of determining that writing has occurred when the written data matches the initial value. Therefore, the information processing apparatus according to the present embodiment manages a case where written data matches the initial value using the IVAT 23. In the following description, descriptions of operations of respective parts similar to those of the first embodiment are omitted.

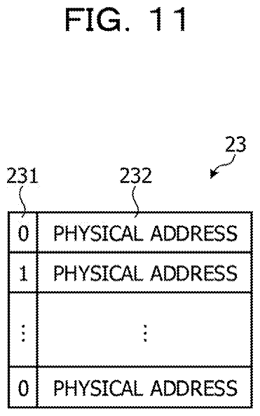

The IVAT 23 is a dedicated data structure that has a certain number of entries and is stored in the DRAM 2. The IVAT 23 holds data illustrated in FIG. 11. FIG. 11 is a diagram illustrating an example of information stored in the IVAT. As illustrated in FIG. 11, in the IVAT 23, a valid bit 231 and a physical address 232 are registered in each entry. Each entry is disposed on each page according to a cache line size. For example, the physical address stored in each entry represents each cache line.

A page table 21 according to the present embodiment may hold a page table entry. For example, the page table 21 according to the present embodiment does not have to hold the update state information 212 in the first embodiment.

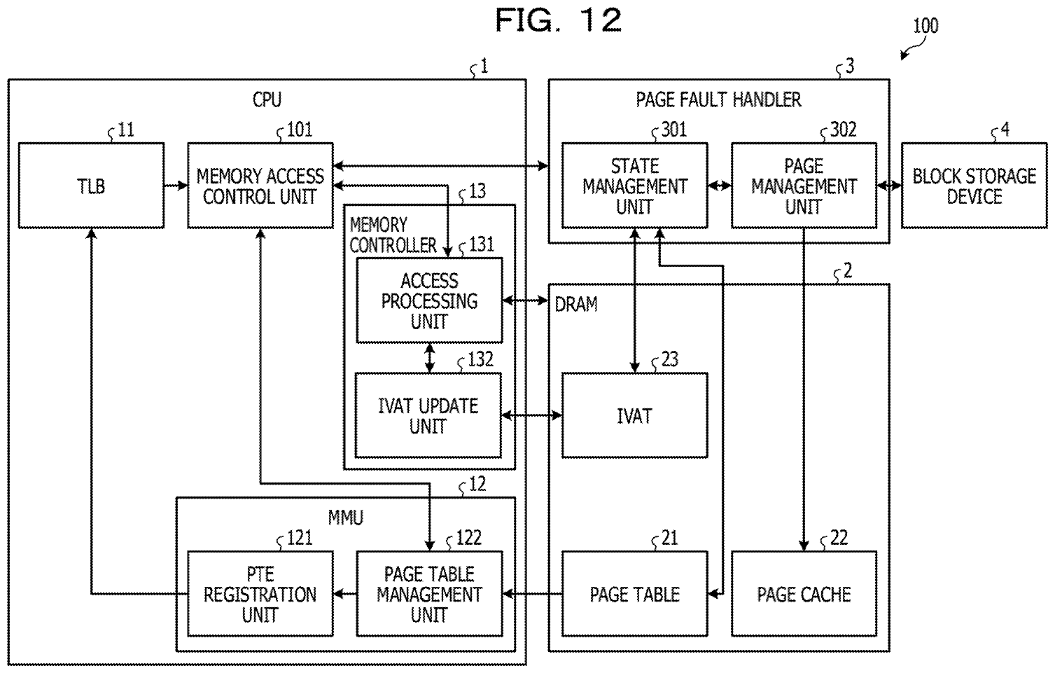

Next, functions of processing a memory access request in the information processing apparatus 100 according to the present embodiment will be described in detail with reference to FIG. 12. FIG. 12 is a block diagram of an information processing apparatus according to a second embodiment.

An MMU 12 according to the present embodiment includes a PTE registration unit 121 and a page table management unit 122. Upon reception of a data access request from a memory access control unit 101, the page table management unit 122 searches the page table 21 using a specified virtual address. The page table management unit 122 checks access right of a target page and checks whether or not the target page exists in the memory (DRAM 2).

The page table management unit 122 outputs a page fault to the memory access control unit 101 when a page table entry of the target page does not exist, when the access right is invalid, or when the target page does not exist in the memory (DRAM 2).

On the other hand, when the page table entry of the target page exists, the access right is valid, and the target page exists in the memory (DRAM 2), the page table management unit 122 outputs a registration instruction of an entry of the TLB 11 to the PTE registration unit 121.

When the PTE registration unit 121 receives the registration instruction of the entry of the TLB 11 from the page table management unit 122, the PTE registration unit 121 registers address translation information indicating a correspondence between a virtual address and a physical address of a target table in the TLB 11.

Upon reception of a memory access request, the memory access control unit 101 searches the TLB 11 using the specified virtual address. When a hit occurs in the TLB 11, the memory access control unit 110 outputs a memory access request including a physical address obtained from the TLB 11 to the memory controller 13.

The memory controller 13 has an access processing unit 131 and an IVAT update unit 132. The access processing unit 131 stores and holds an initial value of the physical address 232 stored in the IVAT 23 in a register which the access processing unit 131 has.

The access processing unit 131 receives an input of a memory access request using a physical address of a target data from the memory access control unit 101. Next, the access processing unit 131 determines whether the memory access request is a write command or not.

When the access request is not a write command, writing of data to be a target of read modify write does not occur, and thus the access processing unit 131 issues a memory access command to the DRAM 2 to execute memory access.

On the other hand, when the access request is a write command, the access processing unit 131 compares the value of the target data with the initial value in the register. Then, when the value of the target data matches the initial value in the register, the access processing unit 131 searches the IVAT 23 to determine whether an entry having a valid bit 231 of 0 exists or not. When no entry having a valid bit 231 of 0 exists in the IVAT 23, the access processing unit 131 waits for a certain period, and then repeats determination of existence of an entry having a valid bit 231 of 0 in the IVAT 23. Here, the case where no entry having a valid bit 231 of 0 exists is a case where a page has been updated but the page fault handler 3 has not yet performed processing for the page. In this case, the access processing unit 131 waits for completion of the page update process by the page fault handler 3.

When an entry having a valid bit of 0 exists in the IVAT 23, the access processing unit 131 changes the valid bit 231 of the entry having the valid bit of 0 to 1 and stores the physical address. Thus, the physical address of the cache line to which the same value as the initial value is written may be identified from the IVAT 23, and the cache line to which the same value as the initial value is written may be updated with the initial value during the page driving-out process. Thereafter, the access processing unit 131 issues a memory access command to the DRAM 2 to execute memory access.

The page management unit 302 allocates an empty page corresponding to the target page on the page cache 22 when a page fault occurs. Next, when the memory access request is a write command, the page management unit 302 outputs a notification of empty page creation to the state management unit 301.

In a case of a page driving-out process from the page cache 22, the page management unit 302 compares data included in a driving-out target page with the initial value for each cache line size. Then, when all of the data are different from the initial value, it may be said that all of the data of the driving-out target page have been updated. Thus, the page management unit 302 writes the driving-out target page to the block storage device 4 to update the page.

On the other hand, when a cache line having a value that matches the initial value exists, the page management unit 302 determines that a cache line in which data has not been updated exists or a cache line in which data has been updated to the initial value exists. Therefore, in order to check whether or not a cache line in which data has been updated to the initial value exists, the page management unit 302 notifies a physical address of the driving-out target page and requests the state management unit 301 to search the IVAT 23.

Thereafter, when a cache line in which data has been updated to the initial value exists in the driving-out target page, the page management unit 302 receives an in-page offset of the cache line from the state management unit 301. When no cache line in which data has been updated to the initial value exists, the page management unit 302 receives no input of information from the state management unit 301.

Then, the page management unit 302 reads, from the block storage device 4, a page corresponding to the driving-out target page having a cache line in which data having a value different from the initial value is stored and a cache line in which data has been updated to the initial value. Next, the page management unit 302 updates the cache line in which data having a value different from the initial value of the read page is stored and the cache line in which the data has been updated to the initial value are updated to the value of the driving-out target page, and stores them in the page cache 22. Thereafter, the page management unit 302 writes the updated page into the block storage device 4. Moreover, the page management unit 302 notifies the state management unit 301 of completion of writing of the driving-out target page, and thereafter deletes the driving-out target page from the page cache 22.

Upon reception of a notification of empty page creation, the state management unit 301 initializes the empty page with a specific value for each cache line size. Thus, when there is no update of data for the empty page, each cache line of the empty page is basically in a state where the initial value is stored, and an update position of data may be specified.

The state management unit 301 receives an instruction to search the IVAT 23 from the page management unit 302. Then, using the physical address of the driving-out target page, it is determined whether or not the physical address in the driving-out target page exists in the IVAT 23. If a relevant physical address exists in the IVAT 23, the state management unit 301 determines that data of a cache line indicated by the physical address has been updated with the initial value. Therefore, the state management unit 301 sets a valid bit of an entry storing the physical address in the driving-out target page to 0. Then, the state management unit 301 outputs an offset of the physical address stored in the IVAT 23 to the page management unit 302 as an offset indicating an address of the cache line having data that has been updated with the initial value.

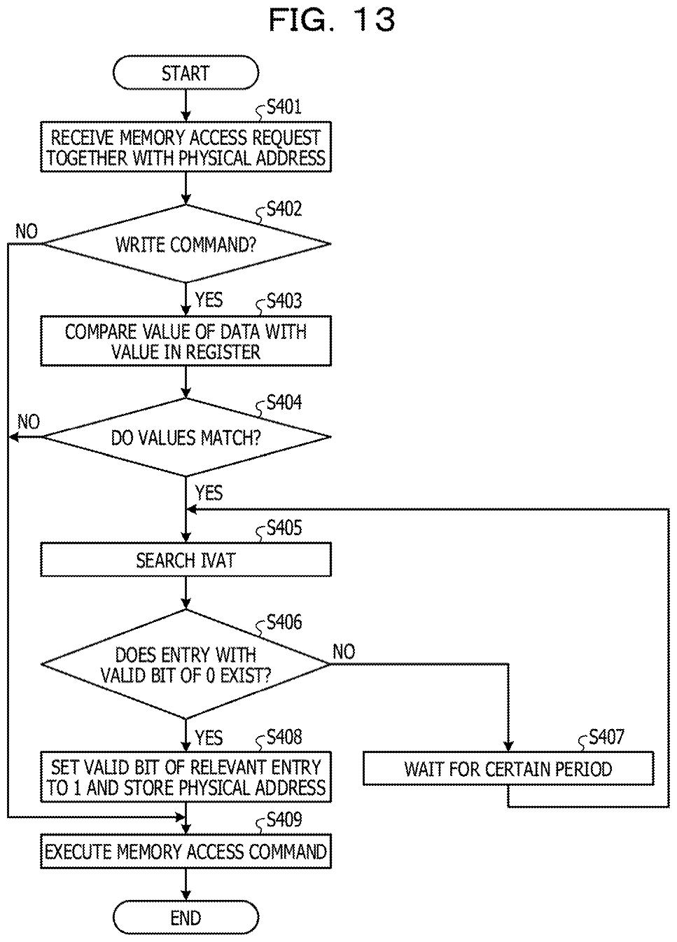

Next, a flow of a memory access process by the memory controller 13 will be described with reference to FIG. 13. FIG. 13 is a flowchart of the memory access process performed by the memory controller according to the second embodiment.

The access processing unit 131 receives a memory access request from the memory access control unit 101 together with a physical address of target data (S401).

Next, the access processing unit 131 determines whether the memory access request is a write command or not (S402). When the access request is not a write command (No in S402), the access processing unit 131 proceeds to S409.

On the other hand, when the access request is a write command (Yes in S402), the access processing unit 131 compares the value of the target data with the initial value in the register (S403).

Then, the access processing unit 131 determines whether or not the value of the target data matches the initial value in the register (S404). Although the possibility that the value of the target data matches the initial value is very low, the possibility that they will match exists. When the value of the target data does not match the initial value in the register (No in S404), the access processing unit 131 proceeds to S409.

On the other hand, when the value of the target data matches the initial value in the register (Yes in S404), the access processing unit 131 outputs an instruction to update the IVAT 23 to the IVAT update unit 132. Upon reception of the instruction to update the IVAT 23, the IVAT update unit 132 searches for the IVAT 23 (S405).

Then, the IVAT update unit 132 determines whether or not there is an entry with a valid bit of 0 (S406).

When no entry with a valid bit of 0 exists (No in S406), the IVAT update unit 132 waits for a certain period (S407). Thereafter, the IVAT update unit 132 proceeds to S405.

When an entry with a valid bit of 0 exists (Yes in S406), the IVAT update unit 132 sets the valid bit of the entry with the valid bit of 0 to 1 and stores the physical address specified by the write command (S408). Thereafter, the IVAT update unit 132 outputs a notification of update completion to the access processing unit 131.

Next, upon reception of the notification of update completion, the access processing unit 131 issues a memory access command according to the access request (S409).

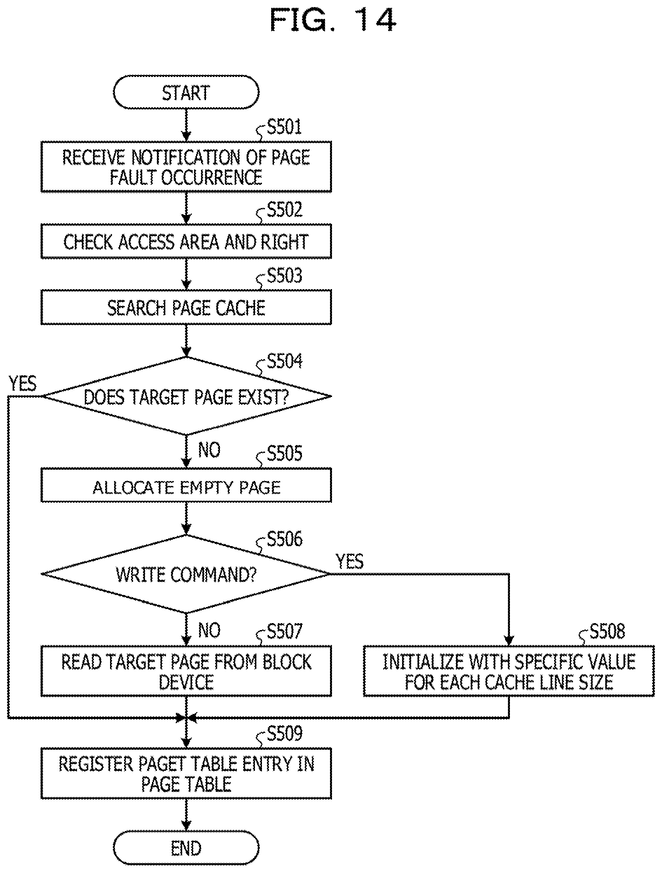

Next, a flow of a page control process by the page fault handler 3 when a page fault occurs according to the present embodiment will be described with reference to FIG. 14. FIG. 14 is a flowchart of the page control process when a page fault occurs according to the second embodiment.

The memory access control unit 101 receives a notification of page fault from the page table management unit 122. Then, the memory access control unit 101 transmits a notification of page fault occurrence to the state management unit 301. The state management unit 301 receives the notification of page fault occurrence from the memory access control unit 101 (S501).

Next, the state management unit 301 checks validity of an access area based on whether or not a virtual address indicating a target page is included in a virtual memory space allocated to the process that has transmitted the memory access request. The state management unit 301 refers to a write flag of the virtual memory space including the virtual address to check whether it is a writable area or not (S502). Here, a case where the access area is valid and is a writable area will be described.

The state management unit 301 outputs a request for searching the page cache 22 to the page management unit 302. Upon reception of the request for searching the page cache 22, the page management unit 302 searches the page cache 22 (S503).

Then, the page management unit 302 determines whether the target page exists in the page cache 22 or not (S504). When the target page exists in the page cache 22 (Yes in S504), the page management unit 302 outputs a notification of hit in the page cache 22 to the state management unit 301, and proceeds to S509.

On the other hand, when the target page does not exist in the page cache 22 (No in S504), the page management unit 302 allocates an empty page corresponding to the target page on the page cache 22 (S505).

Next, the page management unit 302 determines whether the memory access request is a write command or not (S506). When the memory access request is not a write command (No in S506), the page management unit 302 reads the target page from the block storage device 4 (S507). Then, the page management unit 302 stores data of the read target page in the generated empty page in the page cache 22. Thereafter, the page management unit 302 outputs a notification of storage completion of the target page in the page cache 22 to the state management unit 301.

On the other hand, when the memory access request is a write command (Yes in S506), the page management unit 302 outputs a notification of empty page creation to the state management unit 301. Upon reception of the notification of empty page creation, the state management unit 301 initializes the empty page with a specific value for each cache line size (S508).

Thereafter, the state management unit 301 registers a page table entry 211 of the target page in the page table 21 (S509).

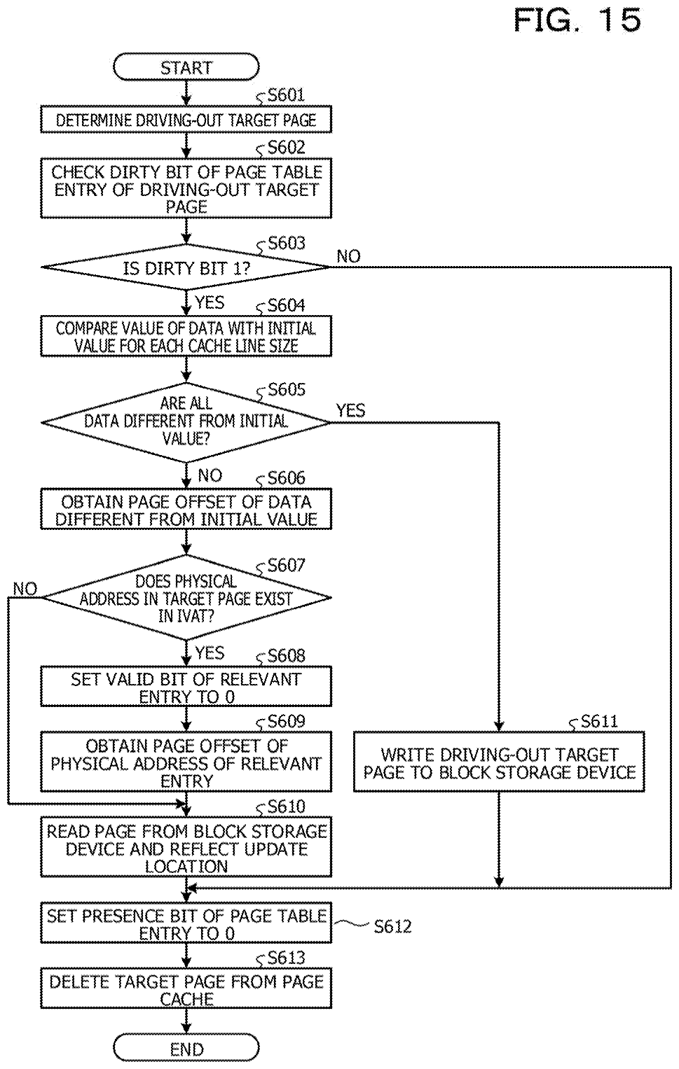

Next, with reference to FIG. 15, a flow of a page driving-out process from the page cache 22 by the page fault handler 3 according to the present embodiment will be described. FIG. 15 is a flowchart of the page driving-out process according to the second embodiment. Here, a process after a start condition of the page driving-out process is satisfied will be described.

The state management unit 301 determines a driving-out target page from pages stored in the page cache 22 by the LRU (S601).

Next, the state management unit 301 checks the dirty bit 216 of the page table entry 211 of the driving-out target page (S602), and determines whether or not new data is written to the driving-out target page (S603). When the dirty bit 216 is 0 (No in S603), the state management unit 301 proceeds to S612.

On the other hand, when the dirty bit 216 is 1 (Yes in S603), the state management unit 301 outputs a request for updating the page to the page management unit 302. Upon reception of an input of the request for updating the page, the page management unit 302 compares a value of data included in the driving-out target page with an initial value of the IVAT 23 for each cache line size (S604).

Then, the page management unit 302 determines whether or not all of data for each cache line size included in the driving-out target page match the initial value of the IVAT 23 (S605).

When a value of data that matches the initial value of the IVAT 23 exist (No in S605), the page management unit 302 obtains a page offset of data having a value that is different from the initial value of the IVAT 23 (S606). Then, the page management unit 302 outputs a physical address of the driving-out target page to the state management unit 301.

The state management unit 301 receives the physical address input from the page management unit 302. Then, the state management unit 301 uses the obtained physical address of the page to determine whether or not the physical address included in the driving-out target page exists in the IVAT 23 (S607). Thus, the state management unit 301 determines whether or not a cache line updated with a value that matches the initial value exists in the driving-out target page.

When the physical address included in the driving-out target page does not exist in the IVAT 23 (No in S607), the state management unit 301 determines that no cache line updated with a value that matches the initial value exists in the driving-out target page, and the process proceeds to S610.

On the other hand, when the physical address included in the driving-out target page exists in the IVAT 23 (Yes in S607), the state management unit 301 sets a valid bit of an entry storing the physical address included in the driving-out target page in the IVAT 23 to 0 (S608).

Next, the state management unit 301 obtains a page offset of the physical address stored in the entry storing the physical address included in the driving-out target page in the IVAT 23 (S609).

Thereafter, the state management unit 301 transmits the page offset and instructs the page management unit 302 to perform a read modify write of the driving-out target page. At this time, when the page offset of the physical address is obtained from the IVAT 23, the state management unit 301 also transmits the offset to the page management unit 302. The page management unit 302 reads a page corresponding to the driving-out target page from the block storage device 4. Then, when the page offset of the physical address is obtained, the page management unit 302 updates the page read by the cache line to which a value that matches the initial value of the driving-out target page is written. On the other hand, when the offset of the physical address is not obtained, the state management unit 301 updates the page read using a page offset of a cache line having a value different from the initial value obtained in S606 with the driving-out target page. Thus, the state management unit 301 reflects the updated position on the read page (S610).

On the other hand, when all of the data of the driving-out target page are different from the initial value (Yes in S605), the page management unit 302 writes the driving-out target page to the block storage device 4 (S611). Thereafter, the page management unit 302 notifies the state management unit 301 of completion of page writing.

Upon reception of the notification of page writing completion from the page management unit 302, the state management unit 301 sets the presence bit 215 of the page table entry 211 corresponding to the page for which writing has been completed to 0 (S612). Then, the state management unit 301 outputs a request for deleting the driving-out target page to the page management unit 302.

The page management unit 302 receives an input of the request for deleting the driving-out target page from the state management unit 301. Then, the page management unit 302 deletes the driving-out target page from the page cache 22 (S613).

As described above, the information processing apparatus according to the present embodiment manages a value of data stored in each cache line and information of a cache line updated using an IVAT. Thus, the information processing apparatus according to the present embodiment may update a page in which data is written at a timing different from a timing at which a write command is received. For example, even when the IVAT is used, it is possible to avoid addition of data read latency from a block storage device in a write process of data, and the write process may be accelerated.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus, comprising:
a first memory whose writing unit is a first size;
a second memory whose writing unit is a second size larger than the first size; and
a processor coupled to the first memory and the second memory and configured to:
receive a write instruction of write data of the first size to the second memory;
generate, in the first memory, a first area of the second size corresponding to a predetermined area of the second size where the write data is written in the second memory;
read stored data stored in the predetermined area of the second memory at a timing different from a timing at which the write instruction is received;
update the stored data with the write data written to the first area;
store the updated stored data in the predetermined area of the second memory; and
write the write data to the first area created in the first memory.

2. The information processing apparatus according to claim 1, wherein the processor is configured to:
generate write position information indicating a write position in the first area where the write data is written;
determine a position to write the write data in the stored data based on the write position information; and
update the stored data based on the determined position.

3. The information processing apparatus according to claim 2, further comprising
a buffer configured to store position information of the first memory corresponding to write destination information indicating a write destination of data,
wherein the processor is configured to:
obtain, when the buffer holds specific position information corresponding to the specific write destination information included in the write instruction, the specific position information from a temporary holding unit;
write the write data to the first memory based on the obtained specific position information;
delete the specific position information from the buffer;
generate the first area when the buffer does not hold the specific position information;
store the write position in the buffer as the specific position information; and
execute the write instruction again.

4. The information processing apparatus according to claim 1, wherein the processor is configured to:
write a specific initial value to an individual area of the first size included in the first area;
extract an area in which a value other than the specific initial value is stored out of the individual area as an area in which write data is written in the first area; and
update the stored data based on the extracted area.

5. An information processing method executed by a processor included in an information processing apparatus, the information processing apparatus including a first memory whose writing unit is a first size, and a second memory whose writing unit is a second size larger than the first size, the information processing method comprising:
receiving a write instruction of write data of the first size to the second memory;
generating, in the first memory, a first area of the second size corresponding to a predetermined area of the second size where the write data is written in the second memory;
reading stored data stored in the predetermined area of the second memory at a timing different from a timing at which the write instruction is received;
updating the stored data with the write data written to the first area;
storing the updated stored data in the predetermined area of the second memory; and
writing the write data to the first area created in the first memory.

6. An information processing method according to claim 5, wherein the updating includes:
generating write position information indicating a write position in the first area where the write data is written;
determining a position to write the write data in the stored data based on the write position information; and
updating the stored data based on the determined position.

7. A non-transitory computer-readable storage medium storing a program that causes a computer to execute a process, the computer including a first memory whose writing unit is a first size and a second memory whose writing unit is a second size larger than the first size, the process comprising:
receiving a write instruction of write data of the first size to the second memory;
generating, in the first memory, a first area of the second size corresponding to a predetermined area of the second size where the write data is written in the second memory;
reading stored data stored in the predetermined area of the second memory at a timing different from a timing at which the write instruction is received;
updating the stored data with the write data written to the first area;
storing the updated stored data in the predetermined area of the second memory; and
writing the write data to the first area created in the first memory.

8. An information processing method according to claim 7, wherein the updating includes:
generating write position information indicating a write position in the first area where the write data is written;
determining a position to write the write data in the stored data based on the write position information; and
updating the stored data based on the determined position.
